(19) United States
(12) Patent Application Publication
(10) Pub. No.: US 2019/0286132 A1
(43) Pub. Date: Sep. 19, 2019

(54) DEVICE FOR ASSISTING A DRIVER OF A VEHICLE TO PERFORM PHYSICAL EXERCISES

(71) Applicant: PSA Automobiles SA, Poissy (FR)

(72) Inventors: Gabriel CREHAN, Vaucresson (FR); Stephanie SCHNEIDER, Suresnes (FR); Thierry CHERIOT, Ollainville (FR); Emmanuelle DIAZ, St. Arnoult En Yvelines (FR)

(21) Appl. No.: 16/461,733

(22) PCT Filed: Dec. 11, 2017
(86) PCT No.: PCT/FR2017/053493

§ 371 Date: May 16, 2019

(30) Foreign Application Priority Data
Dec. 15, 2016 (FR) 1662563

(51) Int. Cl. G05D 1/00; G05D 1/02; B60W 50/14

(52) U.S. Cl. CPC G05D 1/0061; G05D 1/021; B60W 50/14; G05D 2201/0213; B60W 2520/105; B60W 2520/06; B60W 2540/00; B60W 2520/10

(57) ABSTRACT

Device for assisting a driver of a vehicle to perform physical exercises. The invention relates to a device (20) for assisting a driver of a vehicle (15) to perform physical exercises, characterized in that it comprises: —means (21) for acquiring data representative of a driving context, —means (22) for determining a risk level on the basis of the acquired data, —means (23) for selecting at least one physical exercise compatible with the risk level, —means (24) for emitting a signal indicating the at least one selected exercise to the driver.

### CROSS-REFERENCE TO RELATED APPLICATIONS

This application is the US National Stage under 35 USC § 371 of International Application No. PCT/FR2017/053493, filed 11 Dec. 2017 which claims priority to French Application No. 1662563 filed 15 Dec. 2016, both of which are incorporated herein by reference.

### BACKGROUND

The invention relates to devices for assisting the driver, and more particularly, devices for performing physical exercises.

Coaching applications offering a user to perform physical exercises such as running or yoga are known. These activities can be practised in different places: at home, in the office, in a gym or in a park. Such applications generally run on mobile devices such as smartphones or digital tablets.

US20100015585, for example, discloses a method and apparatus for providing personalized audiovisual didactic support for assisting a person to perform positions or movements.

However, these devices are not intended to be used in a vehicle, whether stationary or moving. In particular, a driver of a moving vehicle cannot use such devices in a secure manner.

In a driving situation, some controls (gearbox, steering wheel, brake and acceleration pedals, etc.) must be precisely handled by the driver. This may become particularly complicated if the proposed exercises are too complicated or if they cause too much cognitive load.

### SUMMARY

The invention therefore aims to provide an assisting device for performing physical exercises suitable for use by a driver of a vehicle.

More specifically for this purpose, proposed is an assisting device for a driver of a vehicle to perform physical exercises, wherein the assisting device comprises:
means for acquiring data representative of a driving context,
means for determining a level of risk from the data acquired,
means for selecting at least one physical exercise compatible with the level of risk,
means for transmitting a signal indicating to the driver the at least one selected exercise.

The assisting device allows a driver of a vehicle to perform physical exercises safely. The device adapts the exercises proposed to the driver according to a level of risk related to the driving context of the vehicle.

With the device, it is possible for a driver and/or passengers to use the travel time in a vehicle for physical activity or relaxation activity.

Advantageously, the data representative of a driving context comprise at least one data selected from a vehicle speed, a vehicle acceleration and/or deceleration, and a vehicle change of direction. Also road zones with different levels of danger are considered. These zones (listed in descending order of risk) are, for example: downtown, city, suburb, urban, extra-urban, county road, national road, and highway. Also, the proximity to crossroads presents a danger due to the number of cars that can arise from the right or left requiring a very high level of concentration by the driver. Too much mental overload (or distraction) requires consideration of the proposed movement to be carried out and the level of road risk.

The data used make it possible, for example, to determine whether the vehicle is moving or stopped and to adapt the proposed exercises accordingly.

Advantageously, the assisting device further comprises a memory into which are stored a set of relationships between risk levels, on the one hand, and physical exercises consistent with the levels of risk, on the other hand.

Advantageously, the vehicle comprises at least one autonomous driving mode, and the assisting device further comprises means for determining the driving mode activated in the vehicle, the activated driving mode being taken into account for determining a level risk and/or selecting at least one physical exercise.

Advantageously, the assisting device further comprises means for acquiring parameters related to the driver.

Advantageously, the data representative of a driving context come from vehicle sensors.

According to a variant, the assisting device comprises a software module executed on an on-board computer of the vehicle.

According to another variant, the assisting device comprises a software module executed by a mobile device.

Advantageously, the vehicle comprises at least one autonomous driving mode, and the assisting device further comprises means for determining the driving mode activated in a vehicle.

The invention also relates to a vehicle comprising an assisting device as described above.

### DESCRIPTION OF THE FIGURES

Other characteristics and advantages of the invention will appear hereafter upon examination of the detailed description and attached drawings, in which:

FIG. 1 schematically illustrates a device according to the invention;

FIG. 2 illustrates a first embodiment of the invention;

FIG. 3 illustrates a second embodiment of the invention;

FIG. 4 illustrates a third embodiment of the invention.

The attached drawings will not only serve to complete the invention, but also contribute to its definition, where relevant.

### DETAILED DESCRIPTION

Many people want to use the time spent on a long journey or in traffic jams, to improve their health or prevent certain conditions.

Health, stress, being overweight, fatigue, alertness or medical problems, such as back pain, tendonitis, laxity of the perineum (e.g. after birth or in case of incontinence), are often problems which are ignored or for which no adequate solution is found.

The claimed invention improves this situation by providing a device for safely practicing a physical activity in a vehicle. The object is to improve the well-being and health of the vehicle occupants (passengers and/or driver).

The exercises, proposed by the device and selected according to data such as the vehicle speed or position, allow for practicing exercises safely inside the vehicle.

The device can be implemented in the form of a software application executed on a mobile device or on a computer of the vehicle.

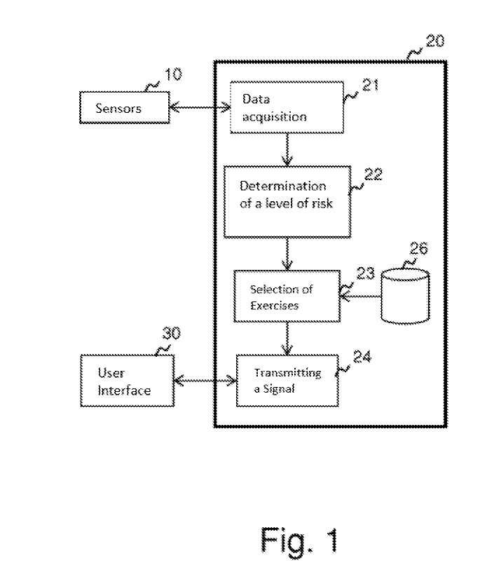

With reference to FIG. 1, the assisting device 20 comprises:
means 21 for acquiring data representative of a driving context from at least one data source 10.
means 22 for determining a level of risk from acquired data,
means 23 for selecting at least one physical exercise compatible with the level of risk,
means 24 for transmitting a signal indicating to the user at least one selected exercise.

Data representative of a driving context includes, for example, the vehicle speed, the vehicle acceleration and/or deceleration, the vehicle change of direction, geolocation data of the vehicle, or any other data enabling the device to determine how the vehicle is driving.

Advantageously, the data representative of a driving context comprise a road zone within which the vehicle drives. Road zones have different levels of danger. These zones (listed in descending order of risk) include, for example, downtown, city, suburb, urban, extra-urban, county road, national road, and highway.

In the case where the assisting device 20 is integrated with a mobile device, the data source 10 comprises, for example, a geolocation module of the mobile device. Such a geolocation module generally comprises a GPS (Global Positioning System) receiver, an accelerometer, a gyroscope, and/or a compass.

Advantageously, the assisting device 20 is connected to a computer of the vehicle. In such case, the assisting device 20 uses data directly from the vehicle (for example, speed, position, acceleration, etc.).

Also the device considers if the car is in “100% autonomous” mode or in manual mode in determining the level of risk. In the autonomous mode, the driver will have the same level of risk as a passenger. As a result, the same exercises can be presented to the driver and the passenger. When resuming car driving, the coach toggles back in driver mode with the appropriate functionalities and exercises for the driver.

This characteristic makes it possible to have data representative of high quality driving context. In this way, the exercises proposed are adapted with even more precision and the risk of practicing an activity in the vehicle is further minimized.

According to another embodiment, the assisting device 20 is connected to a remote server and retrieves data that has been previously downloaded from the vehicle or from connected objects.

The transmitting means 24 transmits a signal to a user interface 30, indicating the exercise to be performed.

In the case where the assisting device 20 is integrated with a mobile device, the user interface 30 comprises the screen of the mobile device or at least a loudspeaker of the mobile device.

In the case where the assisting device 20 is integrated with a vehicle computer, the user interface 30 comprises at least one integrated screen of the vehicle and/or at least one loudspeaker of the vehicle.

The instructions for the proposed exercises are delivered in the form of sounds, images or videos.

Advantageously, the media used to indicate the exercises depends on the level of risk determined.

It is understood that attention is more sustained when viewing a video than when viewing an image. Similarly, attention is more sustained when viewing an image than when listening to an instruction.

Therefore, sound instructions are preferred in the most dangerous situations and videos in the least dangerous situations.

The means 22 for determining a level of risk uses the data acquired to estimate a level of risk.

For example, the higher the speed of the vehicle, the higher the level of risk of exercising becomes. The relationship between the level of risk and the speed of the vehicle can be linear but not necessarily. In addition, the relationship may depend on the exercise for which the level of risk is estimated.

The means 22 for determining a level of risk can also use changes of direction of the vehicle. The greater the vehicle's steering changes, the greater the level of risk for exercising. The relationship between the level of risk and the changes of direction of the vehicle 15 may be linear but not necessarily. In addition, the relationship may depend on the exercise for which the level of risk is estimated.

The vehicle changes of direction are, for example, estimated by:
an angle between two vectors of successive directions of the vehicle,
an angle between an initial position and a current position of the steering wheel.

The means 22 for determining a level of risk can also use the vehicle acceleration or deceleration. The higher the vehicle acceleration or deceleration, the higher the level of risk of exercising becomes. The relationship between the level of risk and the speed of the vehicle can be linear but not necessarily. In addition, the relationship may depend on the exercise for which the level of risk is estimated.

The following table shows an example of a relationship between acquired data and risk levels. There are four levels of risk: low, medium, high, and dangerous.

| | Situation | | |
|---|---|---|---|
| | | Acceleration/ | Change of direction |
| | Vehicle speed | Deceleration | (Number of meters |
| Risk level | (km/h) | (m/s²) | every 50 meters) |
| Low | ≤10 | ≤2 | ≤2 |
| Medium | 10-50 | 2-6 | 2-5 |
| High | 50-130 | 6-8 | ≥5-7 |
| Dangerous | >130 | >8 | >7 |

According to a variant of the device, the level of risk is evaluated independently of the speed of the vehicle, for example, using the position of the vehicle to determine a driving situation such as: vehicle travelling in town, on highway, at a crossroads, at a traffic light, etc.

Also, another variation of the device takes into account the map areas that include: downtown, city, urban, extra urban, countryside, etc.

| | |
|---|---|
| Risk level | Situation |

| | | |
|---|---|---|
| Low | Highway | Extra urban |
| Medium | National road | Urban |
| High | County road | City |
| Dangerous | Crossroads | Downtown |

Note that, in this example the level of risk is not placed according to the speed (as in the previous example), but according to the geographical region or the type of road.

Each of these driving situations is associated with a level of risk.

The device selects or adapts the exercises according to the level of risk determined.

Advantageously, the assisting device further comprises a memory 26 into which are stored a set of relationships between risk levels, on the one hand, and physical exercises consistent with the levels of risk, on the other hand.

When the situation becomes too dangerous (e.g., dangerous level of risk), the application does not offer any exercise.

In addition, the exercises proposed are adapted according to whether the user is a passenger or a driver of the vehicle.

The following table shows an example of a possible exercise based on the estimated level of risk.

| Level of risk | Exercises appropriate based on the level of risk |
|---|---|
| Low | Contraction of the abdominal muscles, |
| | Rotation of the hips with respect to the back, |
| | Pushing hands toward each other to contract the arms |
| | and chest muscles, |
| | Straighten your back, hold your head up and push your |
| | shoulders down to establish and maintain a good sitting |
| | position. |
| Medium | Push knees together to contract the muscles and tendons |
| | of the legs, |
| | Press on knees to stretch the arm muscles, |
| | Rotate the shoulders to relax the muscles and activate |
| | the circulation, |
| | Tilt your head left and right with your head tilted. |
| High | Contraction of the lower muscles, |
| | Contracting the perineum, |
| | Pull your head upward to stretch the muscles and release |
| | tension. |
| Dangerous | No exercise. |

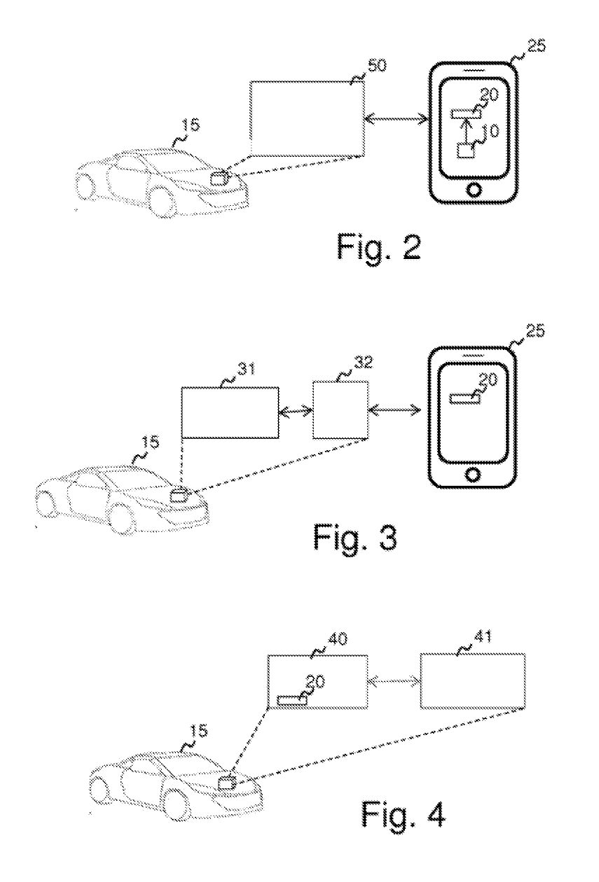

FIG. 2 shows a first exemplary embodiment of the assisting device. In this example, the device 20 is integrated with mobile device 25. The device uses the GPS function of the smartphone. With GPS data, speed and position of the vehicle can be determined.

Optionally, the mobile device 25, depicted in FIG. 2 by a smartphone, is connected by a wired (USB) or wireless (Wifi) type broadband link to a computer 50 of the vehicle. The computer 50 controls, for example, the display of a touch screen integrated in the central portion of the vehicle dashboard. The computer 50 is provided with a solution for duplicating or mirroring the mobile device (for example, Apple CarPlay®, Google Android Auto® or Mirrorlink®) allowing while driving to reproduce in real time, on the touch screen display, and with a suitable visual interface, the display generated by mobile device 25.

This configuration thus enables the driver to visualize the exercises determined by the application on the mobile device 25 or on the touch screen 50 of the vehicle, and to control directly the application via the touch screen. It is preferable that the videos of the movements to be performed are only visible to the driver when at a standstill, and that when the car is in motion, there is a “coach” voice describing the movements to be made together with the proper handling of them. A voice has the double advantage of being a positive stress.

FIG. 3 shows a second exemplary embodiment of the assisting device. In this example, the mobile device 25 exchanges data directly with the computer 31 of the vehicle through a programming interface 32 or API (Application Programming Interface).

This embodiment makes it possible to provide very precise data to the device 20. The estimate of the level of risk is thereby improved. This allows for improved safety for the driver.

FIG. 4 shows a third exemplary embodiment of the assisting device. In this example, the assisting device is integrated with a computer 40 of the vehicle. The vehicle data is then directly available to the assisting device.

This embodiment avoids the use of a mobile device. The user interface is for example, a screen 41 embedded in vehicle 15. Also, the exercise program can be projected on several screens in the car so that everyone may share the session together.

Advantageously, in the case where the vehicle comprises at least one autonomous driving mode, the assisting device 20 further comprises means for determining the driving mode activated in vehicle 15.

The activated driving mode is then taken into account for determining a risk level and/or selecting at least one physical exercise.

For example, if the driving mode enabled is the entirely autonomous driving mode, the determined level of risk is, for example, low regardless of the values of speed and/or acceleration/deceleration, and/or change of direction.

If the activated driving mode is, for example, a driving mode that supports the lateral displacement of the vehicle and does not require the hands of the driver on the steering wheel, then the exercises proposed by determination means 23 are adapted taking into account this parameter. Arm movements may be proposed to the driver.

Advantageously, the device further comprises means for acquiring parameters related to the driver such as identities (so as to propose personalized exercises for the driver), and where appropriate his/her activity (for example, vehicle driver or passenger, stand-by or in audio conference).

These parameters are, for example, communicated by the user in the form of a self-declaration entered via an interface of the device (for example, the touch screen of the mobile device on which the application is executed).

Alternatively, certain parameters are determined at least partly automatically by data acquisition. For example, a position data is used to determine whether a user is at home, at the office or in the vehicle.

1. An assisting device for a driver of a vehicle for performing physical exercises, wherein the assisting device comprises:
means for acquiring data representative of a driving context,
means for determining a level of risk from the acquired data,
means for selecting at least one physical exercise compatible with the level of risk, and
means for transmitting a signal indicating to the driver at least one selected exercise.

2. The assisting device according to claim 1, wherein the data representative of a driving context comprise at least one data selected from a speed of the vehicle, an acceleration and/or a deceleration of the vehicle, a change of direction of the vehicle.

3. The assisting device according to claim 1, wherein the assisting device further comprises a memory in which are stored a set of relationships between levels of risk on the one hand and physical exercises compatible with said levels of risk, on the other hand.

4. The assisting device according to claim 1, wherein the vehicle comprises at least one autonomous driving mode and the assisting device further comprises means for determining the driving mode activated in the vehicle, said activated driving mode being taken into account in determining a risk level and/or selecting at least one physical exercise.

5. The assisting device according to claim 1, wherein the assisting device further comprises means for acquiring parameters related to the driver.

6. The assisting device according to claim 1, wherein the data representative of a driving context come from sensors of the vehicle.

7. The assisting device according to claim 1, wherein the assisting device comprises a software module executed on an on-board computer of the vehicle.

8. The assisting device according to claim 1, wherein the assisting device comprises a software module executed on a mobile device.

9. A vehicle characterized in that the vehicle comprises an assisting device according to claim 1.
